(19) United States
(12) Patent Application Publication
(10) Pub. No.: US 2005/0229242 A1
(43) Pub. Date: Oct. 13, 2005

(54) Interconnecting device, computer readable medium, and communication setting method

(75) Inventors: Takayuki Sato, Tokyo (JP); Jun Haneda, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: ALLIED TELESIS K.K., Tokyo (JP)

(21) Appl. No.: 10/064,658

(22) Filed: Aug. 5, 2002

(30) Foreign Application Priority Data
Aug. 23, 2001 (JP) 2001-253225

(51) Int. Cl. H04L 9/00

(52) U.S. Cl. 726/12

(57) ABSTRACT

An interconnecting device which interconnects communication in a computer network. The interconnecting device includes a first holding unit which holds a removable nonvolatile memory, a reading unit which reads a first device identifier of a first communication device, which is allowed to communicate in the computer network, from the nonvolatile memory held by the first holding unit, and a setting unit which sets a communication setting of the computer network so as to allow the first communication device identified by the first device identifier to communicate in the computer network.

### CROSS REFERENCE TO RELATED APPLICATIONS

This patent application claims priority from a Japanese patent application, No. 2001-253225 filed on Aug. 23, 2001, the contents of which are incorporated herein by reference.

### BACKGROUND OF INVENTION

1. Field of the Invention

The present invention relates to an interconnecting device, a computer readable medium, and a communication setting method. More particularly, the present invention relates to an interconnecting device for setting a communication setting of a computer network.

2. Description of the Related Art

Conventionally, security against illegal access from unauthorized computers into a computer network has been built using a management server which generally manages the computer network. For example, access to the computer network is restricted by user authentication by the management server, VLAN setting or the like.

However, in a conventional computer network system, since the management server restricts access to the computer network, any computer operated by a user connects to the management server via the computer network. Consequently, there is no means to restrict access to the computer network from almost any computer, and there is a problem that any computer is readily allowed to enter the communication through the computer network.

### SUMMARY OF INVENTION

Therefore, it is an object of the present invention to provide an interconnecting device, a communication setting program, and a communication setting method, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, an interconnecting device, which interconnects communication in a computer network, is provided. The interconnecting device includes a first holding unit which holds a removable nonvolatile memory, a reading unit which reads a first device identifier of a first communication device, which is allowed to communicate in a computer network, from a nonvolatile memory held by the first holding unit, and a setting unit which sets a communication setting of computer network to allow the first communication device identified by the first device identifier to communicate in the computer network.

The nonvolatile memory may store the encrypted first device identifier and the interconnecting device may further include a decoder which decodes the encrypted first device identifier read by the reading unit. The setting unit may set the interconnecting device to allow the first communication device identified by the first device identifier to communicate in the interconnecting device. The setting unit may further set a bandwidth of communication of the first communication device, identified by the first device identifier, in the interconnecting device.

The interconnecting device may further include a transmitting unit which transmits the first device identifier to another interconnecting device, which connects to the interconnecting device, to set to allow the first communication device identified by the first device identifier to communicate in the other interconnecting device.

The other interconnecting device connects the computer network and another computer network. The transmitting unit may transmit the first device identifier to the other interconnecting device to allow the first communication device identified by the first device identifier to communicate in the other computer network.

The interconnecting device may further include a transmitting unit which transmits the first device identifier to a management apparatus, which manages the computer network, so as to set to allow the first communication device identified by the first device identifier to communicate in the computer network.

The interconnecting device may further include a second holding unit which holds a removable nonvolatile memory. The reading unit may read a second device identifier of a second communication device, which is allowed to communicate in the computer network, from the nonvolatile memory held by the second holding unit. The setting unit may set a communication setting of the computer network to allow the second communication device identified by the second device identifier to communicate in the computer network.

The setting unit may set the interconnecting device to allow the first communication device identified by the first device identifier to communicate in the interconnecting device. The setting unit may also set the interconnecting device to allow the second communication device identified by the second device identifier to communicate in the interconnecting device.

The interconnecting device may further include a first connection port to which the first communication device connects and a second connection port to which the second communication device connects. The setting unit may set the interconnecting device to allow communication of the first communication device at the first connection port and the second communication device at the second connection port. The setting unit may further set a bandwidth of communication at the first connection port and the second connection port.

The interconnecting device may further include a storage unit which stores a device identifier of at least one of the communication devices, the device identifier allowing the communication device to communicate in the interconnecting device, and a communication controller which restricts access to the interconnecting device from a communication device which is not allowed to communicate in the interconnecting device, based on the device identifier stored in the storage unit.

The setting unit may store the storage unit with the first device identifier read by the reading unit to allow the first communication device identified by the first device identifier read by the reading unit to communicate in the interconnecting device.

The interconnecting device may include a plurality of connection ports to which a plurality of communication devices connect correspondingly and the storage unit may store a device identifier of at least one of the communication devices, the device identifier allowing the communication device to communicate at a corresponding connection port out of the plurality of connection ports, which correspond to a plurality of communication devices respectively.

The second aspect of the present invention provides a communication setting program for an interconnecting device, which sets a communication setting of a computer network. The communication setting program includes a reading module which allows the interconnecting device to read a device identifier of a communication device, which is allowed to communicate in the computer network, from a removable nonvolatile memory. The communication setting program also includes a setting module which allows the interconnecting device to set a communication setting of the computer network to allow a communication device identified by a device identifier to communicate in the computer network.

The setting module may set the interconnecting device to allow a communication device identified by a device identifier to communicate in the interconnecting device.

The communication setting program may further include a transmitting module which allows the interconnecting device to transmit a device identifier to another interconnecting device, connecting to the interconnecting device, to set to allow a communication device identified by the device identifier to communicate in the other interconnecting device.

The third aspect of the present invention provides a communication setting method of a computer network by an interconnecting device, which interconnects communication in the computer network. The communication setting method includes steps of holding a removable nonvolatile memory, reading a device identifier of a communication device, which is allowed to communicate in the computer network, from the held nonvolatile memory, and setting a communication setting of the computer network to allow the communication device identified by the device identifier to communicate in the computer network.

This summary of the present invention does not necessarily describe all necessary features so that the invention may also be a sub-combination of these described features.

### BRIEF DESCRIPTION OF DRAWINGS

FIG. 1 shows a configuration of a computer network 100.

FIG. 2 shows a configuration of an interconnecting device 10a.

FIG. 3 shows a data format of a communication control file stored in a storage unit 110.

FIG. 4 shows a configuration of the computer network 100 and a computer network 200.

FIG. 5 shows hardware components in a management apparatus 20.

### DETAILED DESCRIPTION

The invention will now be described based on preferred embodiments, which do not intend to restrict the scope of the present invention, but rather to exemplify the invention. All of the features and the combinations thereof described in the embodiments are not necessarily essential to the invention.

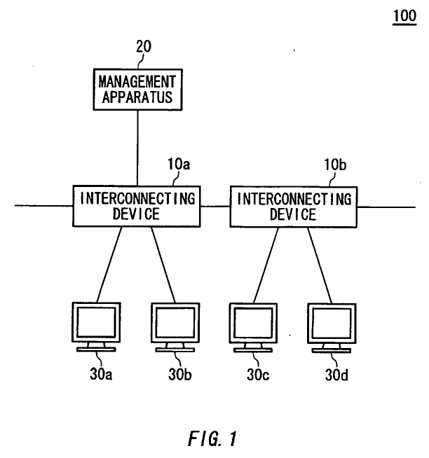

FIG. 1 shows a configuration of a computer network 100 according to one embodiment of the present invention. The computer network 100 of the present embodiment includes interconnecting devices 10a and 10b, such as switching hubs, which interconnect communication in the computer network 100, a management apparatus 20 which manages communication in the computer network 100, and communication devices 30a, 30b, 30c and 30d which are in communication in the computer network 100.

The interconnecting devices 10a and 10b read setting information of the computer network 100 from a nonvolatile memory, such as an IC card, a Miniature card, a diskette or the like, and set a communication setting of the computer network 100. For example, the interconnecting device 10a includes an IC card slot, which are an example of a holding unit to hold a nonvolatile memory, and reads a media access control address (MAC address), as a device identifier of the communication device 30a, from an IC card inserted into the IC card slot by a user of the communication device 30a. Then the interconnecting device 10a set the interconnecting device 10a to allow the communication device 30a identified by the MAC address read from the IC card to communicate in the interconnecting device 10a.

A user of the communication device 30a inserts the IC card into the interconnecting device 10a. The MAC address of the communication device 30a, as an ID to connect the communication device 30a to the computer network 100, is stored in the IC card. Then the user is allowed to log into the computer network 100 from the communication device 30a when the IC card is inserted into the interconnecting device 10a. When the IC card is removed from the interconnecting device 10a, access to the computer network 100 from the communication device 30a is restricted. For example, the user may be prohibited to log into the computer network 100 from the communication device 30a, or only a certain operation, such as accessing to data in the communication devices 30b, 30c or 30d from the communication device 30a, may be allowed.

The interconnecting device 10a transmits the MAC address read from the IC card to the interconnecting device 10b to allow the communication device 30a identified by the MAC address read from the IC card to communicate in the interconnecting device 10b. Then the interconnecting device 10b sets the interconnecting device 10b to allow the communication device 30a identified by the MAC address received from the interconnecting device 10a to communicate in the interconnecting device 10b. In other words, a user of the communication device 30a is allowed to communicate with the communication devices 30c and 30d connected to the interconnecting device 10b from the communication device 10a by inserting the IC card, in which the MAC address for identifying the communication device 30a is stored, into the interconnecting device 10a.

In another example, the interconnecting device 10a transmits the MAC address read from the IC card to the management apparatus 20 to allow the communication device 30a identified by the MAC address read from the IC card to communicate in the computer network 100. Then the management apparatus 20 sets the interconnecting device 10a and 10b to allow the communication device 30a identified the MAC address received from the interconnecting device 10a to communicate in the computer network 100. Then a user of the communication device 30a is allowed to communicate in the computer network 100 from the communication device 30a by inserting the IC card, in which the MAC address for identifying the communication device 30a is stored, into the interconnecting device 10a.

According to the interconnecting devices 10a and 10b of the present embodiment, a designated user has the designated IC card, which is an ID to log into the computer network 100 from a designated communication device operated by the designated user, so that only the designated user who has the designated IC card can be allowed to log into the computer network 100 from the designated communication device. Therefore, illegal access into the computer network 100 can be prevented since only the designated user, who has both the designated communication device and the designated IC card, is allowed to log into the computer network 100.

According to the computer network 100 of the present embodiment, it is possible to prohibit access into the management apparatus 20 from a communication device which is not allowed to communicate in the interconnecting devices 10a and 10b, since access into the computer network 100 from the communication devices 30a, 30b, 30c and 30d can be restricted at the interconnecting devices 10a and 10b. Therefore, the computer network 100 of the present embodiment can build a computer network system with high security against illegal access.

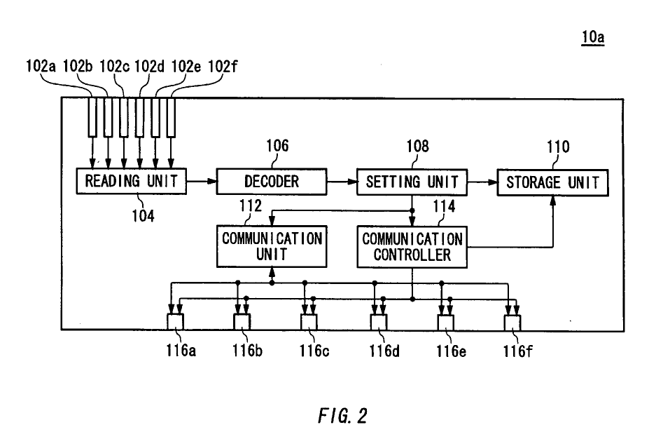

FIG. 2 shows a configuration of the interconnecting device 10a of the present embodiment. Since configurations of the interconnecting device 10a and the interconnecting device 10b are substantially identical, a configuration and operation of merely the interconnecting device 10a will be described hereinafter.

The interconnecting device 10a includes holding units 102a, 102b, 102c, 102d, 102e and 102f, a reading unit 104, a decoder 106, a setting unit 108, a storage unit 110, a communication unit 112, a communication controller 114, and connection ports 116a, 116b, 116c, 116d, 116e and 116f. The holding units 102a, 102b, 102c, 102d, 102e and 102f hold removable nonvolatile memories. The reading unit 104 reads a device identifier of a communication device from the nonvolatile memory. The decoder 106 decodes the encrypted device identifier. The setting unit 108 sets communication setting of the computer network 100 to allow the communication device identified by the device identifier to communicate in the computer network 100. The storage unit 110 stores a device identifier of at least one of communication devices, which is allowed to communicate in the interconnecting device 10a. The communication unit 112 transmits and receives a device identifier. The communication controller 114 restricts access to the interconnecting device 10a from a communication device which is not allowed to communicate in the interconnecting device. The connection ports 116a, 116b, 116c, 116d, 116e and 116f connect to the respective communication devices 30a, 30b, 30c or 30d.

The holding units 102a, 102b, 102c, 102d, 102e and 102f hold nonvolatile memories in which device identifiers of communication devices are stored. Then the reading unit 104 reads the device identifier of the communication device, which is allowed to communicate in the computer network 100, from the nonvolatile memory held by the holding units 102a, 102b, 102c, 102d, 102e or 102f. The decoder 106 decodes the device identifier in the case that the device identifier read from the nonvolatile memory is encrypted. Then the decoder 106 supplies the decoded device identifier to the setting unit 108.

The setting unit 108 sets a communication setting of the computer network 100 to allow a communication device identified by a device identifier read from a nonvolatile memory to communicate in the computer network 100. The setting unit 108 sets the interconnecting device 10a to allow a communication device identified by a device identifier read from a nonvolatile memory to communicate in the interconnecting device 10a. Specifically, the setting unit 108 allows a communication device identified by a device identifier read from a nonvolatile memory to communicate in the interconnecting device 10a by storing in the storage unit 110 the device identifier read from the nonvolatile memory.

Then the communication controller 114 restricts access to the interconnecting device 10a from a communication device, which is not allowed to communicate in the interconnecting device, based on the device identifier stored in the storage unit 110. In other words, the communication controller 114 allows the communication device identified by the device identifier read from a nonvolatile memory and stored in the storage unit 110 to communicate in the interconnecting device 10a. For example, the communication controller 114 refers to header information of data received by the communication unit 112 and allows the communication unit 112 to transmit the data when the device identifier of the communication device in the header information is consistent with the device identifier stored in the storage unit 110.

The communication unit 112 receives a device identifier of a communication device, the device identifier allowing the communication device to communicate in the interconnecting device 10a, from the interconnecting device 10b. Then the setting unit 108 allows the communication device identified by the device identifier received by the communication unit 112 to communicate in the interconnecting device 10a by storing in the storage unit 110 the device identifier received by the communication unit 112.

If appropriate, the communication unit 112 transmits a device identifier read from a nonvolatile memory to the interconnecting device 10b, which connects to the interconnecting device 10a, so as to allow a communication device identified by the device identifier read from the nonvolatile memory to communicate in the interconnecting device 10b. The communication unit 112 may transmit a device identifier read from a nonvolatile memory to the management apparatus 20, which manages the computer network 100, so as to set to allow a communication device identified the device identifier read from the nonvolatile memory to communicate in the computer network 100.

The setting unit 108 may set bandwidth of communication, in the interconnecting device 10a, of a communication device identified by a device identifier read from a nonvolatile memory. For example, the setting unit 108 may set a priority order for each of the plurality of connection ports. In another occasion, the setting unit 108 may set upper limitation of bandwidth for each of the plurality of connection ports.

Each of the holding units 102a, 102b, 102c, 102d, 102e and 102f may correspond to each of the connection ports 116a, 116b, 116c, 116d, 116e and 116f. In other words, the communication controller 114 may restrict communication, in the interconnecting device 10a, of a communication device connected to the connection port 116a based on a device identifier read from a nonvolatile memory held by the holding unit 102a, and may restrict communication, in the interconnecting device 10a, of a communication device connected to the connection port 116b based on a device identifier read from a nonvolatile memory held by the holding unit 102b.

For example, the reading unit 104 reads the device identifier of the communication device 30a, which is allowed to communicate in the computer network 100, from the nonvolatile memory held by the holding unit 102a. The reading unit 104 also reads the device identifier of the communication device 30b, which is allowed to communicate in the computer network 100, from the nonvolatile memory held by the holding unit 102b.

Then the setting unit 108 stores in the storage unit 110 the device identifier so as to allow the communication device 30a identified by the device identifier read from the nonvolatile memory held by the holding unit 102a to communicate at the connection port 116a. The setting unit 108 also stores in the storage unit 110 the device identifier so as to allow the communication device 30b identified by the device identifier read from the nonvolatile memory held by the holding unit 102b to communicate at the connection port 116b. Then the communication controller 114 restricts access from a communication device, which is not allowed to communicate in the interconnecting device, based on the device identifier stored in the storage unit 110.

The communication controller 114 may restrict communication, in the interconnecting device 10a, from the communication devices 30c and 30d connecting to the interconnecting device 10b based on a device identifier read from a nonvolatile memory held by a holding unit of the interconnecting device 10b. The setting unit 108 may set bandwidth of communication at the connection ports 116a, 116b, 116c, 116d, 116e and 116f.

According to the interconnecting device 10a of the present embodiment, leak of a device identifier in a nonvolatile memory can be prevented since the interconnecting device 10a reads an encrypted device identifier of a communication device from a nonvolatile memory and decode it. Also according to the interconnecting device 10a of the present embodiment, a communication channel in the computer network 100 can be used effectively since the interconnecting device 10a can set bandwidth, in the interconnecting device 10a, of each of communication devices or each of connection ports based on setting information in a nonvolatile memory inserted into the interconnecting device 10a. Also according to the computer network 100 of the present embodiment, a computer network system with high security against illegal access can be built since each of the interconnecting devices restricts access to the respective interconnecting device from a communication device which is not allowed to communicate in the interconnecting devices.

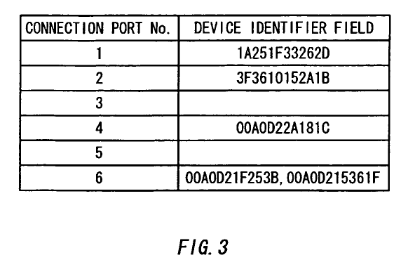

FIG. 3 shows an example of a data format of a communication control file stored into the storage unit 110. The communication control file includes a connection port number field and a device identifier field. The connection port number field stores the connection port number which is assigned to identify each of a plurality of connection ports in the interconnecting device. The device identifier field stores a device identifier to identify a communication device. For example, the device identifier field stores a MAC address of the communication device.

In the present embodiment, the connection port number of connection port 116a is 1, the connection port number of connection port 116b is 2, the connection port number of connection port 116c is 3, the connection port number of connection port 116d is 4, the connection port number of connection port 116e is 5, and the connection port number of connection port 116f is 6.

The communication control file corresponds to each of the plurality of connection ports and stores a device identifier of at least one communication device, the device identifier allowing the communication device to communicate at the corresponding connection port of the plurality of connection ports. For example, the communication controller 114 refers to header information of data received at a designated connection port and allow the communication unit 112 to transmit the data when the device identifier of the communication device included in the header information and the connection port number to which the communication device connects are consistent with the device identifier and the connection port number stored in the communication control file.

A nonvolatile memory, which stores a device identifier for identification of a communication device, is inserted by a user of the communication device into one of the holding unit 102a, 102b, 102c, 102d, 102e or 102f, so that a device identifier in a nonvolatile memory is stored in the communication control file. When the nonvolatile memory is removed from one of the holding unit 102a, 102b, 102c, 102d, 102e or 102f by the user, the device identifier stored in the communication control file is deleted.

The communication controller 114 allows a communication device identified by a device identifier 1A251F33262D to communicate at the connection port 116a (connection port number 1). The communication controller 114 allows a communication device identified by a device identifier 3F3610152A1B to communicate at the connection port 116b (connection port number 2). The communication controller 114 allows a communication device identified by a device identifier 00A0D22A181C to communicate at the connection port 116d (connection port number 4).

The communication controller 114 allows a communication device identified by a device identifier 00AOD21F253B and a communication device identified by a device identifier 00AOD215361F to communicate at the connection port 116f (connection port number 6). This is the case where the communication device identified by the device identifier 00A0D21F253B and the communication device identified by a device identifier 00A0D215361F connect to the connection ports of the interconnecting device 10b which connects to the connection port 116f.

According to the interconnecting device 10a of the present embodiment, only access from a designated communication device is allowed at a corresponding connection port by restricting access from a communication device at each of the plurality of connection ports. Consequently, a computer network system with high security against illegal access can be built.

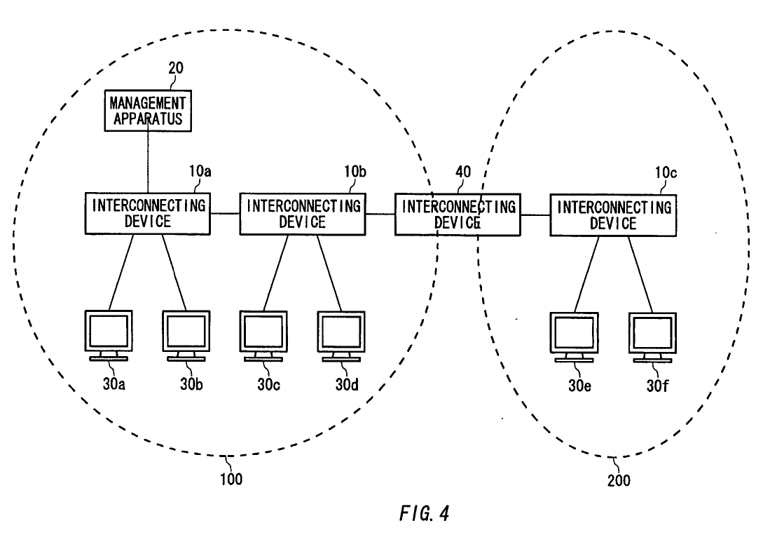

FIG. 4 shows an example of a configuration of the computer network 100 and a computer network 200. The configuration of the computer network 100 is as same as the configuration depicted in FIG. 1. The computer network 200 includes an interconnecting device 10c, such as a switching hub, which interconnects communication in the computer network 200, and communication devices 30e and 30f which are in communication in the computer network 200. Segment of the computer network 100 is different from segment of the computer network 200 and an interconnecting device 40, such as a bridge or a router, connects the computer network 100 and the computer network 200.

A user of the communication device 30a inserts a nonvolatile memory into the holding unit 102a of the interconnecting device 10. Then the interconnecting device 10a transmits a device identifier, which identifies the communication device 30a, read from the nonvolatile memory, to the interconnecting device 40 via the interconnecting device 10b so as to allow the communication device 30a to communicate in the computer network 200. Then the interconnecting device 40 allows the communication device 30a identified by the device identifier received from the interconnecting device 10a to communicate in the interconnecting device 40. Consequently, the communication device 30a is allowed to communicate with the communication devices 30e and 30f in the computer network 200 whose segment is different from the computer network 100.

According to the interconnecting device 10a of the present embodiment, a user of a communication device can be allowed to log into a computer network whose segment is different from segment to which the communication device belongs, by inserting a nonvolatile memory into an interconnecting device which is directly connected to the communication device.

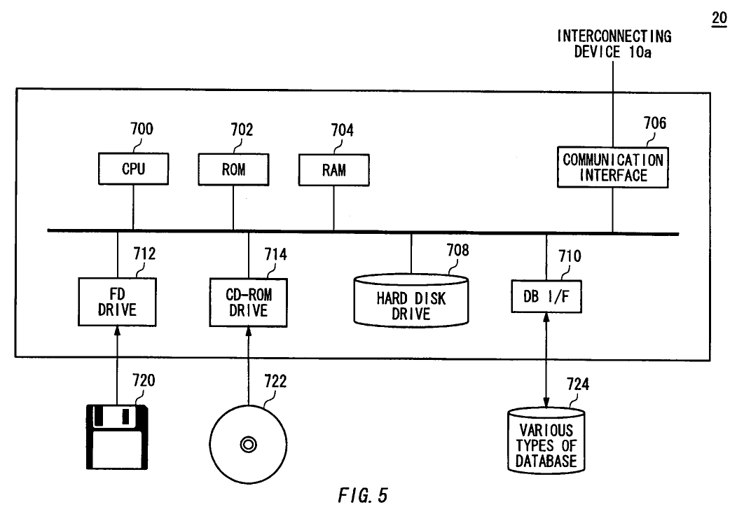

FIG. 5 shows hardware components in the management apparatus 20. The management apparatus 20 includes a CPU 700, a ROM 702, a RAM 704, a communication interface 706, a hard disk drive 708, a database interface 710, a diskette drive 712 and a CD-ROM drive 714. The CPU 700 controls each section based on program in the ROM 702 and RAM 704. The communication interface 706 communicates with the interconnecting device 10a via a computer network. The database interface 710 writes data to a database and updates contents of the database.

The diskette drive 712 reads data or program from a diskette 720 and transmits the data or the program to the communication interface 706. The CD-ROM drive 714 reads data or program from a CD-ROM 722 and transmits the data or the program to the communication interface 706. The communication interface 706 transmits the data or the program from the diskette drive 712 or the CD-ROM drive 714 to the interconnecting device 10a. The database interface 710 connects to various types of databases 724 and transmits and receives data to/from the various types of databases 724.

Program supplied to the interconnecting device 10a is stored on a recording medium, such as the diskette 720 or the CD-ROM 722, which is provided by a user. The program in the recording medium may be either compressed or decompressed. The program is read from the recording medium, installed on the interconnecting device 10a via the communication interface 706, and executed on the interconnecting device 10a.

The program stored in the recording medium, that is, the program to be installed on the interconnecting device 10a includes a reading module, a setting module, a decoding module, a transmitting module, a storing module and a communication control module as a functional configuration. Explanation of the modules shall be omitted since each operation, which is performed by the instruction from each of the modules, is identical with that of the corresponding device in the interconnecting device 10a, which has been explained in connection with FIGS. 1 to 4.

Function of some or all of operations of the interconnecting device 10a in all embodiments in the present application can be stored in the diskette 720 or the CD-ROM 720, which is examples of recording media, shown in FIG. 5.

These programs may be read directly from the recording medium and be executed by the interconnecting device 10a, or may be executed after the programs are installed in the interconnecting device 10a. The programs may be stored either on a single recording medium or a plurality of recording media. The program may be stored in an encoded form.

It is possible to use an optical recording medium such as DVD or PD, a magneto-optical recording medium such as Minidisk, a tape medium, a magnetic recording medium or a semiconductor memory such as an IC card or a Miniature Card as a recording medium instead of the diskette or the CD-ROM. A storage device, such as a hard disk or a RAM in a server system on a dedicated communication network or the Internet, may be used as a recording medium and program may be provided to the interconnecting device 10a via the communication network. Such recording media shall be used only for manufacturing the interconnecting device 10a and it is obvious that manufacturing or selling of such recording media, in the course of trade, shall be deemed to be an infringement of a patent right based on this application.

Although the present invention has been described by way of exemplary embodiments, it should be understood that many changes and substitutions may be made by those skilled in the art without departing from the spirit and the scope of the present invention which is defined only by the appended claims.

1. An interconnecting device which interconnects communication in a computer network to which plural communication devices connect, comprising:
a first holding unit which holds a memory storing thereon device identifiers;
a reading unit operatively connecting to said first holding unit, said reading unit reading a first device identifier of a first communication device of the communication devices, which is allowed to communicate in the computer network, from the memory held by said first holding unit; and
a setting unit operatively connecting to said reading unit, said setting unit setting a communication setting of the computer network to allow the first communication device identified by said first device identifier to communicate in the computer network.

2. The interconnecting device as claimed in claim 1, wherein the memory unit stores therein the encrypted first device identifier, and the interconnecting device further comprising a decoder connecting to said reading unit, which decodes the encrypted first device identifier read by said reading unit.

3. The interconnecting device as claimed in claim 1, wherein said setting unit sets the interconnecting device to allow the first communication device identified by the first device identifier to communicate in the interconnecting device.

4. The interconnecting device as claimed in claim 3, wherein said setting unit further sets a bandwidth, in the interconnecting device, of communication of the first device communication device identified by the first device identifier.

5. The interconnecting device as claimed in claim 3, further comprising a transmitting unit which transmits the first device identifier to another interconnecting device, connecting with the interconnecting device, thereby to allow the first communication device identified by the first identifier to communicate in the other interconnecting device.

6. The interconnecting device as claimed in claim 5, wherein the other interconnecting device connects the computer network and another computer network, and said transmitting unit transmits the first device identifier to the other interconnecting device thereby to allow the first communication device identified by the first identifier to communicate in the other computer network.

7. The interconnecting device as claimed in claim 3, further comprising a transmitting unit operatively connecting to said setting unit and transmitting the first device identifier to a management apparatus of the computer network which manages the computer network to allow the first communication device identified by the first device identifier to communicate in the computer network.

8. The interconnecting device as claimed in claim 1, further comprising a second holding unit operatively connecting to said reading unit and holding a memory, wherein said reading unit reads a second device identifier of a second communication device of the plural communication devices, which is allowed to communicate in the computer network, from the memory held by said second holding unit; and
said setting unit sets the communication setting of the computer network to allow the second communication device identified by the second device identifier to communicate in the computer network.

9. The interconnecting device as claimed in claim 8, wherein said setting units sets the interconnecting device to allow the first communication device identified by the first device identifier to communicate in the interconnecting device, and sets the interconnecting device to allow the second communication device identified by the second device identifier to communicate in the interconnecting device.

10. The interconnecting device as claimed in claim 9, further comprising a first connection port to which the first communication device connects and a second connection port to which the second communication device connects, wherein said setting unit set the interconnecting device to allow communication of the first communication device at said first connection port and the second communication device at said second connection port.

11. The interconnecting device as claimed in claim 10, wherein said setting unit further sets a bandwidth of communication at both said first connection port and said second connection port.

12. The interconnecting device as claimed in claim 1, further comprising:
a storage unit which stores therein a device identifier of at least one communication device, the device identifier allowing the communication device to communicate in the interconnecting device; and
a communication controller connecting to said storage unit and restricting access to the interconnecting device from a communication device which is not allowed to communicate in the interconnecting device, based on the device identifier stored in said storage unit.

13. The interconnecting device as claimed in claim 12, wherein said setting unit stores in said storage unit the first device identifier read from said reading unit so as to allow the first communication device identified by the first device identifier read from said reading unit to communicate in the interconnecting device.

14. The interconnecting device as claimed in claim 12, further comprising a plurality of connection ports to which a plurality of communication devices connect respectively, wherein said storage unit stores therein a device identifier of at least one of the communication devices, the device identifier allowing the communication device to communicate at a corresponding connection port out of said plurality of connection ports, which correspond to a plurality of communication devices respectively.

15. A computer readable medium storing thereon a communication setting program for a interconnecting device, which sets a communication setting of a computer network, the program comprising:
a reading module which allows the interconnecting device to read a device identifier of a communication device, which is allowed to communicate in the computer network, from a removable nonvolatile memory; and
a setting module which allows the interconnecting device to set a communication setting of the computer network to allow the communication device identified by the device identifier to communicate in the computer network.

16. The computer readable medium as claimed in claim 15, wherein said setting module sets the interconnecting device to allow the communication device identified by the device identifier to communicate in the interconnecting device.

17. The computer readable medium as claimed in claim 16, further comprising a transmitting module which allows the interconnecting device to transmit the device identifier to the other interconnecting device, connecting to the interconnecting device, to set to allow the communication device identified by the device identifier to communicate in the other interconnecting device.

18. A communication setting method of the computer network by the interconnecting device, which interconnects communication in the computer network, comprising steps of:
holding a memory,
reading from the memory a device identifier of a communication device, which is allowed to communicate in the computer network; and
setting a communication setting of the computer network to allow the communication device identified by the device identifier to communicate in the computer network.
